(19) United States
(12) Patent Application Publication
(10) Pub. No.: US 2024/0336308 A1
(43) Pub. Date: Oct. 10, 2024

(54) LOAD BEARING VEHICLE ATTACHMENT SERIES

(71) Applicants: Sterling Petersen, Salem, UT (US); David Ballard, Leeds, UT (US)

(72) Inventors: Sterling Petersen, Salem, UT (US); David Ballard, Leeds, UT (US)

(21) Appl. No.: 18/626,160

(22) Filed: Apr. 3, 2024

Related U.S. Application Data
(60) Provisional application No. 63/494,155, filed on Apr. 4, 2023.

(51) Int. Cl. B62D 33/02; B60R 9/06

(52) U.S. Cl. CPC B62D 33/0207; B60R 9/06

(57) ABSTRACT

Aa configurable bed rack. The configurable bed rack includes a first riser and a second riser. Each riser includes a base, the base configured to rest on the sides of a truck bed. Each riser also includes a first vertical portion, where the first vertical portion is configured to extend vertically from the side of the truck bed and a second vertical portion, where the second vertical portion is configured to extend vertically from the side of the truck bed. The configurable bed rack further includes a crossbar, where the crossbar is configured to extend from the first riser to the second riser.

### CROSS-REFERENCE TO RELATED APPLICATIONS

This application claims the benefit of and priority to U.S. Provisional Patent Application Ser. No. 63/494,155 filed on Apr. 4, 2023, which application is incorporated herein by reference in its entirety.

### BACKGROUND OF THE INVENTION

The main problem with current vehicle rack attachments is that they only work in one place on the vehicle. A ‘hitch’ rack is only compatible with your receiver hitch, a truck bed rack is only compatible with your truck bed, and a roof rack is only compatible with your roof.

Another problem is that various current rack designs are only compatible with one item. For example, a bike rack can only carry bikes and a kayak rack can only carry kayaks, and so forth with any kind of rack. This results in the consumer having to own one rack per activity or load type, resulting in consumers owning several various racks.

Another problem is that rack attachments for vehicles are not compatible with each other. A roof rack and a hitch rack cannot work in conjunction with each other, same to be said with a truck bed rack and a hitch rack.

Accordingly, there is a need in the art for a system that can transfer between places on your vehicle with only a few adjustments, can carry multiple load types, and can work in conjunction with the various versions of the same rack.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a configurable bed rack. The configurable bed rack includes a first riser. The first riser includes a base, the base configured to rest on the sides of a truck bed. The first riser also includes a first vertical portion, where the first vertical portion is configured to extend vertically from the side of the truck bed and a second vertical portion, where the second vertical portion is configured to extend vertically from the side of the truck bed. The configurable bed rack also includes a second riser. The second riser includes a base, the base configured to rest on the sides of a truck bed. The second riser also includes a first vertical portion, where the first vertical portion is configured to extend vertically from the side of the truck bed and a second vertical portion, where the second vertical portion is configured to extend vertically from the side of the truck bed. The configurable bed rack further includes a crossbar, where the crossbar is configured to extend from the first riser to the second riser.

Another example embodiment includes a configurable hitch rack. The configurable hitch rack includes an insert, where the insert is configured to be inserted in a hitch of a vehicle and an incline, where the incline is attached to the insert. The configurable hitch rack also includes a column, where the column is configured to be vertical when the insert is within the hitch of the vehicle and a crossbar, where the crossbar is attached to the column. The configurable hitch rack further includes a rail, where the rail is attached to the column below the crossbar.

Another example embodiment includes a truck. The truck includes a configurable bed rack. The configurable bed rack includes a first riser. The first riser includes a base, the base resting on a first side of a truck bed. The first riser also includes a first vertical portion, where the first vertical portion extends vertically from the first side of the truck bed and a second vertical portion, where the second vertical portion extends vertically from the first side of the truck bed. The configurable bed rack also includes a second riser. The second riser includes a base, the base resting on a second side of a truck bed. The second riser also includes a first vertical portion, where the first vertical portion extends vertically from the second side of the truck bed and a second vertical portion, where the second vertical portion extends vertically from the second side of the truck bed. The configurable bed rack further includes a crossbar, where the crossbar extends from the first riser to the second riser. The truck also includes a configurable hitch rack. The configurable hitch rack includes an insert, where the insert is inserted in a hitch of the truck and an incline, where the incline is attached to the insert. The configurable hitch rack also includes a column, where the column extends vertically from the incline and a crossbar, where the crossbar is attached to the column. The configurable hitch rack further includes a rail, where the rail is attached to the column below the crossbar.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a perspective view of the configurable bed rack;

FIG. 1B illustrates a side view of the configurable bed rack;

FIG. 1C illustrates a front view of the configurable bed rack;

FIG. 2A is a perspective view of the configurable hitch rack;

FIG. 2B is a side view of the configurable hitch rack;

FIG. 3 illustrates an example of a vehicle with a configurable bed rack and configurable hitch rack both attached to the vehicle;

FIG. 4A is a perspective view of the example of a T-track crossbar;

FIG. 4B is a side view of the example of a T-track crossbar; and

FIG. 5 illustrates an example of an alternative T-track crossbar.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

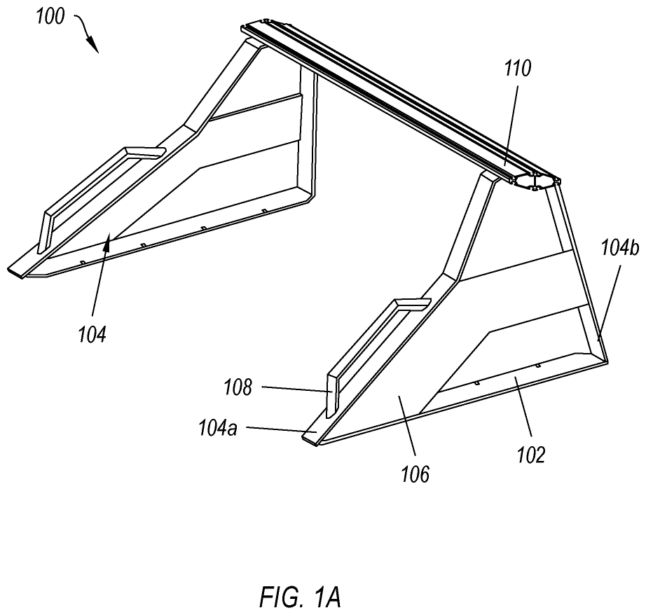

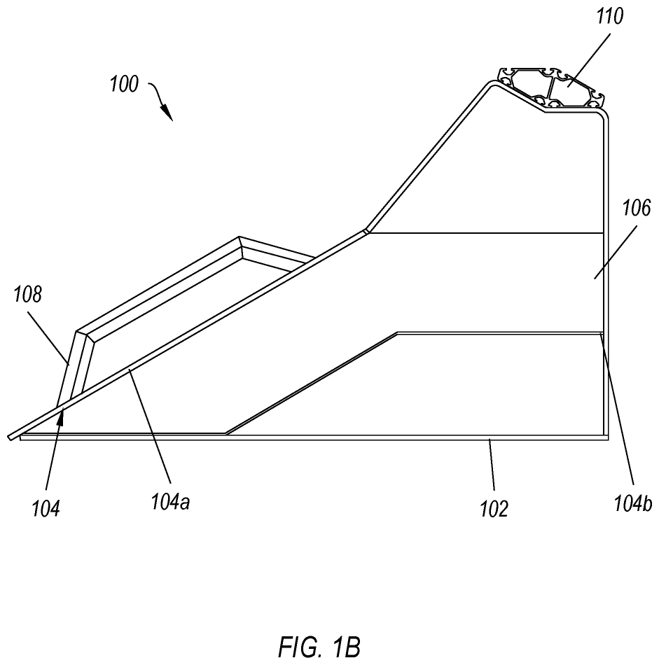

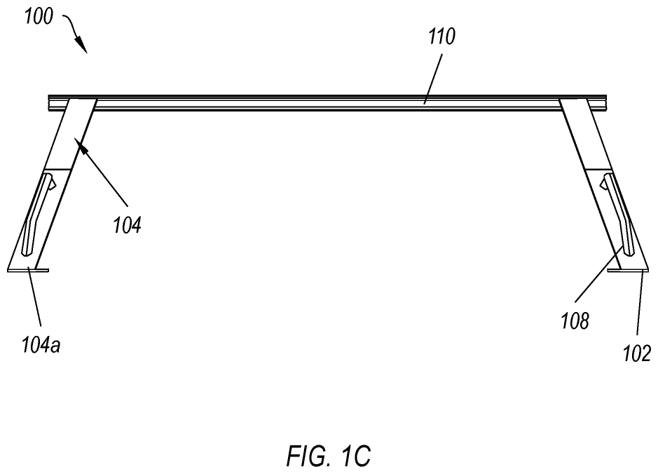

FIGS. 1A, 1B and 1C (collectively “FIG. 1”) illustrate an example of a configurable bed rack 100. FIG. 1A illustrates a perspective view of the configurable bed rack 100; FIG. 1B illustrates a side view of the configurable bed rack 100; and FIG. 1C illustrates a front view of the configurable bed rack 100. The configurable bed rack 100 is capable of holding many different types of loads. I.e., the configurable bed rack 100 allows a user to haul different loads without changing out the configurable bed rack 100. For example, a user can use the configurable bed rack 100 to haul a canoe, then remove the canoe and attach bikes to the configurable bed rack 100 without changing out the configurable bed rack 100 itself.

FIG. 1 shows that the configurable bed rack 100 can include a base 102. The base 102 is configured to rest on the sides of a truck bed. The base 102 supports the weight of the configurable bed rack 100 and transfers the weight to the sides of a truck bed. The base is a rectangular piece that approximately matches a portion of the sides of a truck bed. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

FIG. 1 also shows that the configurable bed rack 100 can include a riser 104. The riser 104 includes a first portion 104a and a second portion 104b. The riser 104 is an upright or nearly upright portion which allows the configurable bed rack 100 to rise above the truck bed. I.e., the riser 104 increases the height of the configurable bed rack to be near the height of the truck cab. This allows longer articles, such as a canoe, to rest on the configurable bed rack 100 and extend over the cab of the truck. In addition, the riser 104 helps transfer weight to the base 102.

FIG. 1 further shows that the configurable bed rack 100 can include a brace 106. The brace connects the first portion 104a to the second portion 104b. I.e., the brace 106 prevents the first portion 104a and the second portion 104b from moving apart from one another or toward one another, adding strength to the configurable bed rack 100.

FIG. 1 additionally shows that the configurable bed rack 100 can include a handle 108. The handle 108 provides support for a user when in the truck bed. I.e., the handle 108 gives the user a place to hold onto when using the configurable bed rack 100 or when in the truck bed doing other things.

FIG. 1 moreover shows that the configurable bed rack 100 can include a crossbar 110. The crossbar 110 is where an item can be attached to the configurable bed rack 100. The crossbar 110 can directly support the item. For example, a canoe can rest directly on the crossbar 110. Likewise, the crossbar 110 can receive an attachment to support other items, such as a bike, as described below. Because the crossbar 110 rests on the riser 104, the two sides of the configurable bed rack 100 can have different spacing, depending on the width of the truck bed.

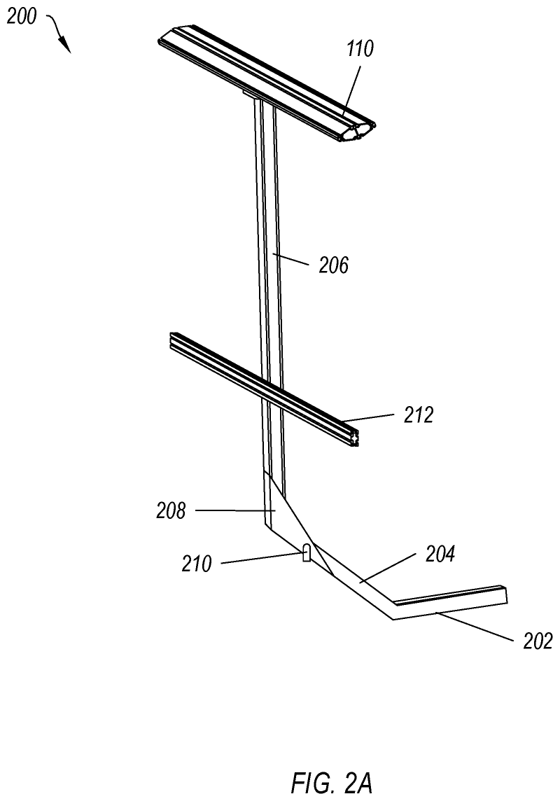

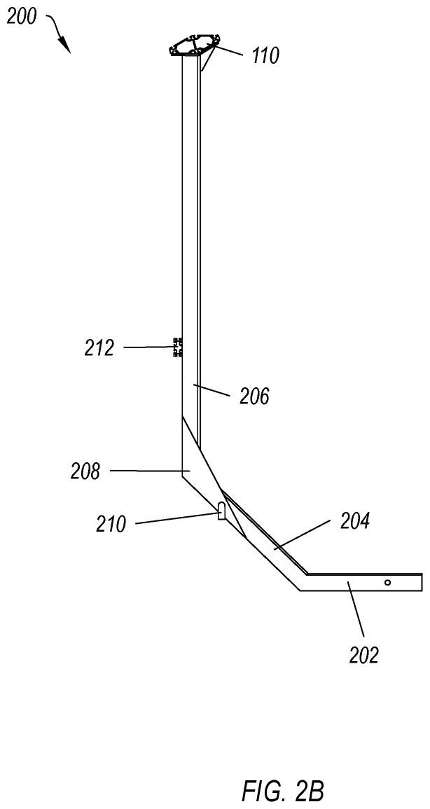

FIGS. 2A and 2B illustrate an example of a configurable hitch rack 200. FIG. 2A is a perspective view of the configurable hitch rack 200 and FIG. 2B is a side view of the configurable hitch rack 200. The configurable hitch rack 200 is capable of holding many different types of loads. I.e., the configurable hitch rack 200 allows a user to haul different loads without changing out the configurable hitch rack 200. For example, a user can use the configurable hitch rack 200 to haul a canoe, then remove the canoe and attach bikes to the configurable hitch rack 200 without changing out the configurable hitch rack 200 itself. The configurable hitch rack 200 is configured to work with the configurable bed rack 100 of FIG. 1 such that they can support a single long item or multiple items as desired by the user.

FIG. 2 shows that the configurable hitch rack 200 can include an insert 202. The insert 202 is configured to be inserted into a hitch on a truck or other vehicle. I.e., the insert 202 is square and can be inserted into existing hitches, without the need for a new attachment or connection to the vehicle. The insert 202 creates an approximately horizontal base for the configurable hitch rack 200. The insert is of sufficient length to allow a truck bed to be lowered without removing the configurable hitch rack 200. For example, the insert 202 can be between 10 and 14 inches in length. In particular, the insert 202 can be approximately 12 inches in length. As used in the specification and the claims, the term approximately shall mean that the value is within 10% of the stated value, unless otherwise specified.

FIG. 2 also shows that the configurable hitch rack 200 can include an incline 204. The incline 204 is attached to the insert 202 at an approximately 45 degree angle. The incline 204 allows for a transition from horizontal to vertical within the configurable hitch rack 200 while still accommodating a tailgate. I.e., the incline 204 allows the vertical portion of the configurable hitch rack 200 to be far enough from the vehicle that a tailgate can be lowered and raised while the configurable hitch rack 200 remains attached. The incline 204 is between 13 and 17 inches long. In particular the incline can be approximately 15 inches long. This makes the end of the incline 204 between 18 and 19 inches from the hitch, depending on insertion depth.

FIG. 2 further shows that the configurable hitch rack 200 can include a column 206. The column 206 raises the attachment point between the configurable hitch rack 200 and an item attached to the configurable hitch rack. I.e., the column 206 is a vertical portion that allows items to be stored at a level higher than the hitch of the vehicle. The column 206 is attached to the incline 204 at an approximately 45 degree angle.

FIG. 2 additionally shows that the configurable hitch rack 200 can include a brace 208. The brace 208 secures the column 206 to the incline 204. I.e., the brace 208 allows the downward forces of the item onto the incline 204 and from there to the insert 202. That is, the weight placed on the configurable hitch rack 200 creates a torque on the incline 204 which is resisted by the brace 208.

FIG. 2 moreover shows that the configurable hitch rack 200 can include a pin 210. The column 206 is rotatable relative to the incline 204 and the brace 208. This allows the column 206 to be lowered relative to the vehicle without removing the configurable hitch rack 200. I.e., the column 206 can be leaned away from the vehicle. The pin 210 secures the column 206 within the brace 208, preventing the column 206 from being lowered. For example, while the vehicle is being driven, the column 206 should be in a vertical position and the pin 210 secures it in the desired position.

FIG. 2 also shows that the configurable hitch rack 200 can include a crossbar 110. The crossbar 110 is where an item can be attached to the configurable bed rack 100. The crossbar 110 can directly support the item. For example, a canoe can rest directly on the crossbar 110. Likewise, the crossbar 110 can receive an attachment to support other items, such as a bike, as described below. The crossbar 110 rests on the column 206 but can be adjusted side to side if needed, as described below.

FIG. 2 further shows that the configurable hitch rack 200 can include a rail 212. The rail 212 is lower than the crossbar 110. The rail 212 has multiple functions. For example, the rail 212 prevents mounted items from swinging toward the vehicle. E.g., if the front tire of a bike is attached to the crossbar 110 then the rear wheel will hang down. During driving, the bike would act like a pendulum, swinging back and forth and may continually hit the rear of the vehicle causing damage. The rail 212 prevents the bike from being able to swing in this way. Indeed, the rear wheel of the bike can be attached to the rail 212, preventing any swinging of the bike. I.e., the rail 212 can provide a second point of attachment for the item.

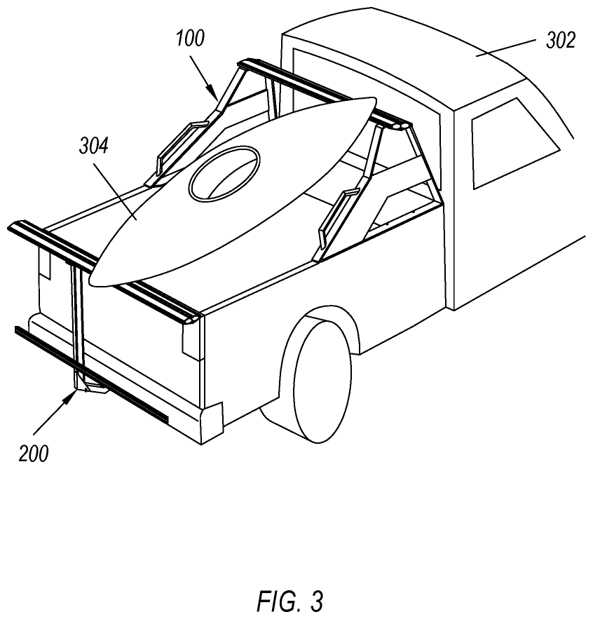

FIG. 3 illustrates an example of a vehicle 302 with a configurable bed rack 100 and configurable hitch rack 200 both attached to the vehicle 302. With both a configurable bed rack 100 and configurable hitch rack 200 both attached, even long items can be secured. Alternatively, the configurable bed rack 100 and configurable hitch rack 200 can secure different items. For example, motorcycles can be secured to the configurable bed rack 100 and bikes can be secured to the configurable hitch rack 200.

By way of example, FIG. 3 shows a kayak 304 attached to both the configurable bed rack 100 and configurable hitch rack 200. Typically, a kayak 304 is too large to be placed on a single crossbar. However, because the combination of the configurable bed rack 100 and configurable hitch rack 200 has two crossbars, the kayak 304 can be secured without taking up room in the truck bed.

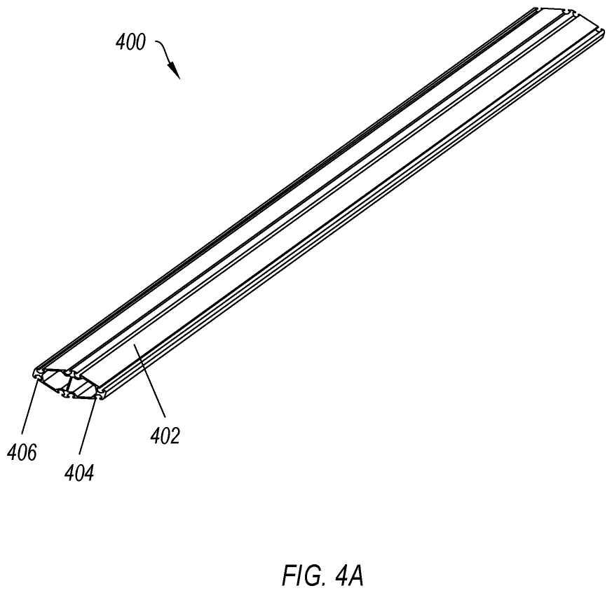

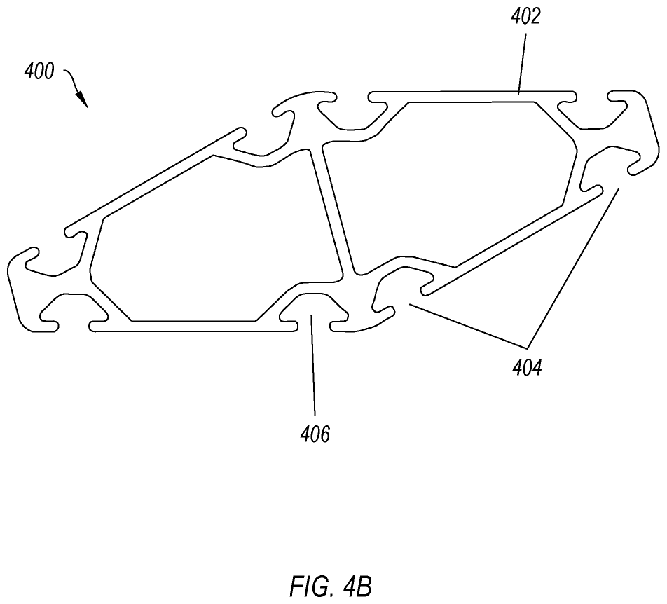

FIGS. 4A and 4B (collectively “FIG. 4”) illustrate an example of a T-track crossbar 400. FIG. 4A is a perspective view of the example of a T-track crossbar 400; and FIG. 4B is a side view of the example of a T-track crossbar 400. The T-track crossbar 400 can be used as the crossbar 110 in either a configurable bed rack 100 or a configurable hitch rack 200, as described above. The T-track crossbar 400 callows for multiple attachment sites and mounting positions.

FIG. 4 shows that the T-track crossbar 400 can include a body 402. The body 402 is the basic outline of the T-track crossbar. The body 402 is a diamond shape. A diamond shape is beneficial because it provides optimal angles for attaching devices, such as bikes. In addition, the diamond shape allows the T-track crossbar 400 to be used both in a configurable bed rack or a configurable hitch rack. I.e., a user can move the T-track crossbar 400 as needed. The body 402 can be made from extruded aluminum or any other desired material.

The body 402 is of sufficient length to cover the whole truck bed. I.e., the body 402 is long enough that it traverses the truck bed from side to side. This ensures that regardless of the width of the truck bed it can rest on the supports. Likewise, the crossbar on the configurable hitch rack should be equal in size to the crossbar on the configurable bed rack to allow longer items to rest on both simultaneously. Therefore, the length of the body 402 should be between 56 and 64 inches. For example the body 402 can be approximately 60 inches long.

FIG. 4 shows that the edges of the T-track cross bar 400 can each include a pair of tracks 404. The pair of tracks 404 are configured to receive an insert. In particular, the pair of tracks 404 allow a desired attachment to be secured to the body 402. The insert can prevent the attachment from being removed until desired. In particular, the insert is allowed to move within the track 404 but cannot be inserted or removed from the pair of tracks 404 except at the end. That is, movement of the insert within the pair of tracks 404 is only allowed in a single dimension. I.e., the insert is placed in the pair of tracks 404 at the edge of the body 402 then moved down the body 402 to the desired position. While this means that the inserts and attachments must be placed in the pair of tracks 404 in the desired order, the attachment is very secure. Likewise, a pair of tracks 404 can be used to attach the T-track crossbar 400 to a configurable rack.

FIG. 4 shows that the pair of tracks 404 each include an aperture 406, with the opening narrower than the body of the aperture 406. This allows the head of an insert to be placed within the aperture 406 and as long as the head is wider than the opening, the head of the insert will remain within the aperture 406 unless removed from the side of the body 402. Likewise, any attachment, such as a bungee cord, can be hooked into the aperture 402, remaining secure.

For example, a bolt or series can be placed in a riser or column with the heads protruding form the riser. The head of the bolts can then be inserted into the tracks 404. The aperture then stops the T-track crossbar 400 from being removed from the configurable rack.

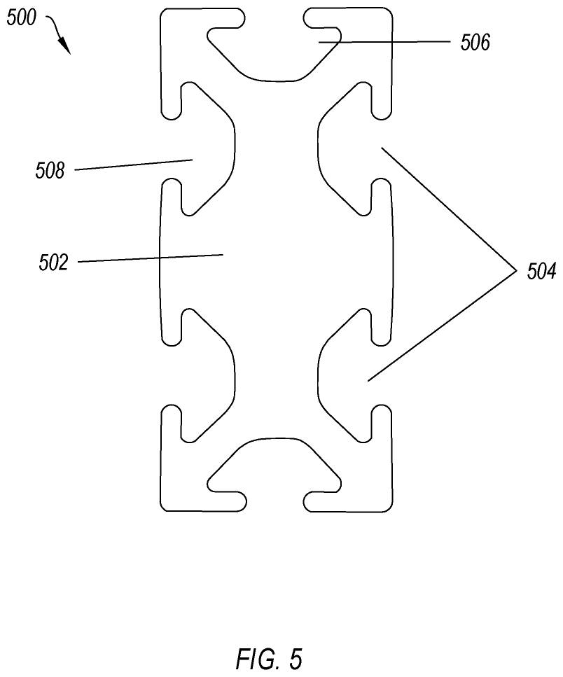

FIG. 5 illustrates an example of an alternative T-track crossbar 500. The alternative T-track crossbar 500 has a different profile, which allows for a different attachment that the T-track crossbar of FIG. 4. For example, the alternative T-track crossbar 500 can be used as the rail of a configurable hitch rack.

FIG. 5 shows that the alternative T-track crossbar 500 can include a body 502. The body 502 is the basic outline of the alternative T-track crossbar. The body 502 is a rectangular shape. A rectangular shape is beneficial because it attaches well to a vertical support and the symmetry allows for ease of attachment. The body 502 can be made from extruded aluminum or any other desired material.

The body 502 is of sufficient length to cover the whole truck bed. I.e., the body 502 is long enough that it traverses the truck bed from side to side. This ensures that it can work with a T-track crossbar either on a configurable hitch rack or a configurable bed rack to secure items. Therefore, the length of the body 502 should be between 56 and 64 inches. For example the body 502 can be approximately 60 inches long.

FIG. 5 shows that the edges of the alternative T-track cross bar 500 can each include a pair of tracks 504 on one pair of sides and a single tracks 506 on the other pair of sides. The pairs of tracks 504 and single tracks 506 are configured to receive an insert. In particular, the pairs of tracks 504 and the single tracks 506 allow a desired attachment to be secured to the body 502. In particular, the pairs of tracks 504 secures the alternative T-track crossbar 500 to a rack and the single tracks 506 can allow an attachment to be connected. The insert can prevent the attachment from being removed until desired. In particular, the insert is allowed to move within the track 504 or 506 but cannot be inserted or removed from the pairs of tracks 504 or the single tracks 506 except at the end. That is, movement of the insert within the pairs of tracks 504 or the single tracks 506 is only allowed in a single dimension. I.e., the insert is placed in the pairs of tracks 504 or single tracks 506 at the edge of the body 502 then moved down the body 502 to the desired position. While this means that the inserts and attachments must be placed in the pairs of tracks 504 or the single tracks 506 in the desired order, the attachment is very secure. Likewise, a pairs of tracks 504 or the single tracks 506 can be used to attach the alternative T-track crossbar 500 to a configurable rack.

FIG. 5 shows that the pairs of tracks 504 and single tracks 506 each include an aperture 508, with the opening narrower than the aperture 508. This allows the head of an insert to be placed within the aperture 508 and as long as the head is wider than the opening, the head of the insert will remain within the aperture 508 unless removed from the side of the body 502. Likewise, any attachment, such as a bungee cord, can be hooked into the aperture 502, remaining secure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A configurable bed rack, the configurable bed rack comprising:
a first riser, wherein the first riser includes:
a base, the base configured to rest on the sides of a truck bed;
a first vertical portion, wherein the first vertical portion is configured to extend vertically from the side of the truck bed; and
a second vertical portion, wherein the second vertical portion is configured to extend vertically from the side of the truck bed;
a second riser, wherein the second riser includes:
a base, the base configured to rest on the sides of a truck bed;
a first vertical portion, wherein the first vertical portion is configured to extend vertically from the side of the truck bed; and
a second vertical portion, wherein the second vertical portion is configured to extend vertically from the side of the truck bed; and
a crossbar, wherein the crossbar is configured to extend from the first riser to the second riser.

2. The configurable bed rack of claim 1, wherein each riser further includes a brace, wherein the brace connects the first vertical portion to the second vertical portion.

3. The configurable bed rack of claim 1, wherein each riser further includes a handle.

4. The configurable bed rack of claim 1, wherein the crossbar includes a T-track crossbar.

5. The configurable bed rack of claim 4, wherein the T-track crossbar includes a body, wherein the body is diamond shape.

6. The configurable bed rack of claim 5, wherein each edge of the diamond includes a pair of tracks.

7. The configurable bed rack of claim 6, wherein each track includes:
an aperture; and
an opening into the aperture, wherein the opening is narrower than the aperture.

8. The configurable bed rack of claim 6 further comprising:
a pair of bolts on the first riser, wherein each of the pair of bolts has a head within an aperture of the T-track crossbar; and
a pair of bolts on the second riser, wherein each of the pair of bolts has a head within an aperture of the T-track crossbar.

9. The configurable bed rack of claim 1 further comprising a locking clamp, wherein the locking clamp is configured to attach the riser to the bed of a truck.

10. A configurable hitch rack, the configurable hitch rack comprising:
an insert, wherein the insert is configured to be inserted in a hitch of a vehicle;
an incline, wherein the incline is attached to the insert;
a column, wherein the column is configured to be vertical when the insert is within the hitch of the vehicle;
a crossbar, wherein the crossbar is attached to the column; and
a rail, wherein the rail is attached to the column below the crossbar.

11. The configurable hitch rack of claim 10, wherein the angle between the insert and the incline is approximately 45 degrees.

12. The configurable hitch rack of claim 11, wherein the angle between the column and the incline is approximately 45 degrees.

13. The configurable hitch rack of claim 10 further comprising a brace, wherein the brace secures the column to the incline.

14. The configurable hitch rack of claim 13, wherein the column is rotatable relative to the brace.

15. The configurable hitch rack of claim 10 further comprising a pin, wherein the pin is configured to hold the column relative to the brace.

16. The configurable hitch rack of claim 10 wherein the crossbar is attached to the top of the column.

17. The configurable hitch rack of claim 10, wherein the crossbar includes a T-track crossbar.

18. The configurable hitch rack of claim 10, wherein the rail includes a body, wherein the body:
includes a T-track crossbar; and
is a rectangle shape.

19. The configurable bed rack of claim 18, wherein:
a first side of the rectangle includes a pair of tracks; and
a second side of the rectangle includes a single track;
wherein the second side is opposite the first side.

20. A truck, wherein the truck includes:
a configurable bed rack, the configurable bed rack comprising:
a first riser, wherein the first riser includes:
a base, the base resting on a first side of a truck bed;
a first vertical portion, wherein the first vertical portion extends vertically from the first side of the truck bed; and
a second vertical portion, wherein the second vertical portion extends vertically from the first side of the truck bed;
a second riser, wherein the second riser includes:
a base, the base resting on a second side of the truck bed;
a first vertical portion, wherein the first vertical portion extends vertically from the second side of the truck bed; and
a second vertical portion, wherein the second vertical portion extends vertically from the second side of the truck bed; and
a crossbar, wherein the crossbar extends from the first riser to the second riser; and
a configurable hitch rack, the configurable hitch rack comprising:
an insert, wherein the insert is inserted in a hitch of the truck;
an incline, wherein the incline is attached to the insert;
a column, wherein the column extends vertically from the incline;
a crossbar, wherein the crossbar is attached to the column; and
a rail, wherein the rail is attached to the column below the crossbar.
